(19) United States
(12) Patent Application Publication
(10) Pub. No.: US 2007/0294518 A1
(43) Pub. Date: Dec. 20, 2007

(54) SYSTEM AND METHOD FOR PREDICTING TARGET ADDRESS OF BRANCH INSTRUCTION UTILIZING BRANCH TARGET BUFFER HAVING ENTRY INDEXED ACCORDING TO PROGRAM COUNTER VALUE OF PREVIOUS INSTRUCTION

(76) Inventor: Shen-Chang Wang, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/423,962

(22) Filed: Jun. 14, 2006

(51) Int. Cl. G06F 15/00

(52) U.S. Cl. 712/238

(57) ABSTRACT

A system for determining the target address of a branch instruction is disclosed. The system includes: a branch target buffer (BTB), containing at least an entry storing the target address of the branch instruction, the entry being indexed according to a program counter (PC) value of an instruction prior to the branch instruction; a PC register, containing a PC value of a current instruction; and a comparator, coupled to the PC register and the BTB, for comparing the PC value of the current instruction with an output of the BTB corresponding to a previous instruction.

### BACKGROUND OF THE INVENTION

1. Field of the Invention

The invention relates to BTB technology, and more particularly, to a BTB memory that does not have cycle penalties.

2. Description of the Prior Art

A branch instruction is an instruction that jumps to a target address different from a sequential instruction. A conditional branch is one that only jumps to said target address if a certain condition is true. In such a case the branch is not always taken, but the processing steps for testing the condition still need to be carried out. To try and reduce this overhead, many systems utilize branch prediction, which predicts whether a particular branch will be taken. Branch target prediction predicts the target address of a particular branch, by utilizing a branch target buffer (BTB).

A BTB contains many branch instructions, indexed according to their program counter (PC) values. The BTB also contains the PC tag of each branch instruction, and a history of whether or not the branch has been taken. Each time a branch is executed, this information will be updated, thereby enabling a processor to predict the future behavior of the branch.

Please refer to FIG. 1. FIG. 1 is a diagram of a first BTB system 100 according to the prior art. The prior art BTB system 100 comprises a BTB memory 20; a PC register 30; a comparator 40; and a multiplexer (MUX) 50. Initially, a PC value is input to the PC register 30 and the BTB memory 20. The BTB memory 20 uses the PC value to search for a stored instruction. If there is a BTB hit, the BTB memory 20 will output the PC tag of the stored instruction to the comparator 40, where it is compared with the PC value output by the PC register 30. The comparison result is input to the multiplexer 50, for selecting a next PC value PC_Next be output to the BTB memory 20 and the PC register 30. If the two values are the same, it is determined that the current instruction is a branch instruction and the next PC value PC_Next is the PC value of the branch instruction target address. If the two values are not the same, i.e. the current instruction is not a branch instruction, then the multiplexer 50 will output a next sequential PC value, e.g. the PC value of the current instruction+4, as the next PC value PC_Next.

In order to speed up the operation of the BTB system 100 described above, the fetch operation is pipelined into multiple stages F1 and F2. Please refer to FIG. 2. FIG. 2 is a diagram of a second BTB system 200 according to the prior art. The prior art BTB system 200 has the same components as the system 100, but further comprises a first buffer 25 and a second buffer 35 to establish a pipeline architecture. In a first stage, the BTB memory 20 and the PC register 30 output a PC tag and a PC value to the first buffer 25 and the second buffer 35 respectively. In a second stage, the PC tag and the PC value buffered in the first buffer 25 and the second buffer 35 are output to the comparator 40, and the comparison result is input to the multiplexer 50, for determining the next PC value PC_Next.

If a branch instruction is found, the system will jump to the target address of said branch instruction. However, a sequential instruction has already been input to the PC register and the BTB and will have to be cancelled. In a system where a branch instruction is usually taken, this canceling significantly slows the operation and therefore limits the maximum speed of the microprocessor, e.g. the CPU.

### SUMMARY OF THE INVENTION

It is therefore an objective of the present invention to provide a system and method for branch target prediction that can prevent the above-mentioned problem.

With this in mind, a system for determining a target address of a branch instruction is disclosed. The system comprises: a branch target buffer (BTB), containing at least an entry storing the target address of the branch instruction, the entry being indexed according to a program counter (PC) value of an instruction prior to the branch instruction; a PC register, containing a PC value of a current instruction; and a comparator, coupled to the PC register and the BTB, for comparing the PC value of the current instruction with an output of the BTB corresponding to a previous instruction.

A method is also disclosed. The method comprises: providing a branch target buffer (BTB), containing at least an entry storing the target address of the branch instruction, the entry being indexed according to a program counter (PC) value of an instruction prior to the branch instruction; receiving a PC value of a current instruction; utilizing the received PC value to output a BTB entry and the PC value of the current instruction; and comparing the PC value of the current instruction with the BTB entry corresponding to the previous instruction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a first BTB system according to the prior art.

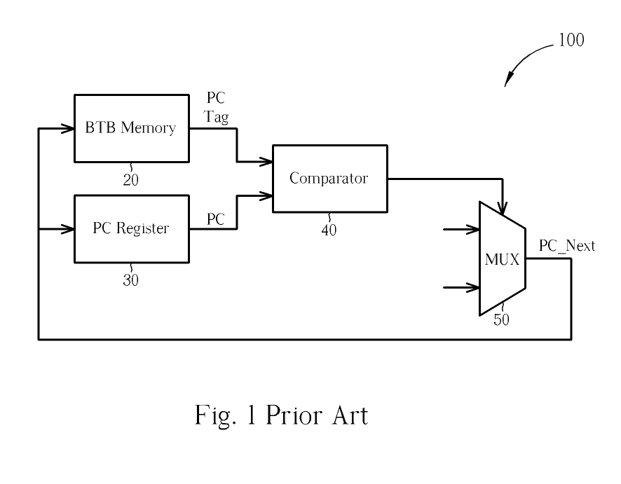

FIG. 2 is a diagram of a second BTB system according to the prior art.

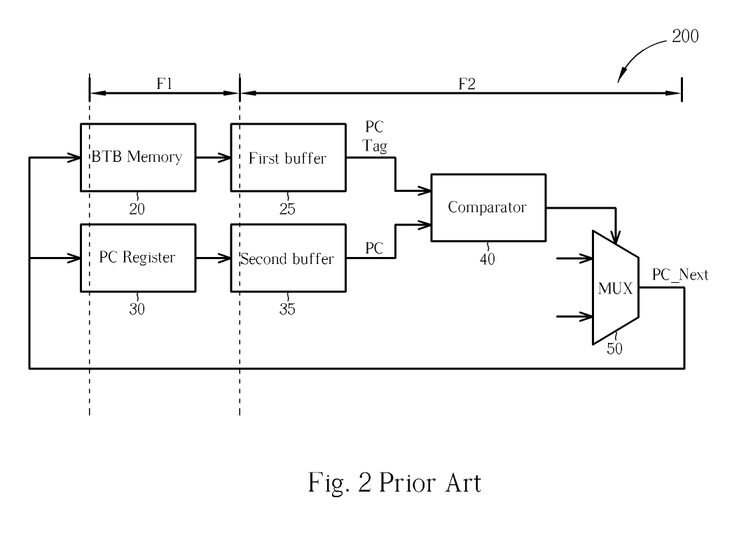

FIG. 3 is a diagram of a BTB system according to an embodiment of the present invention.

### DETAILED DESCRIPTION

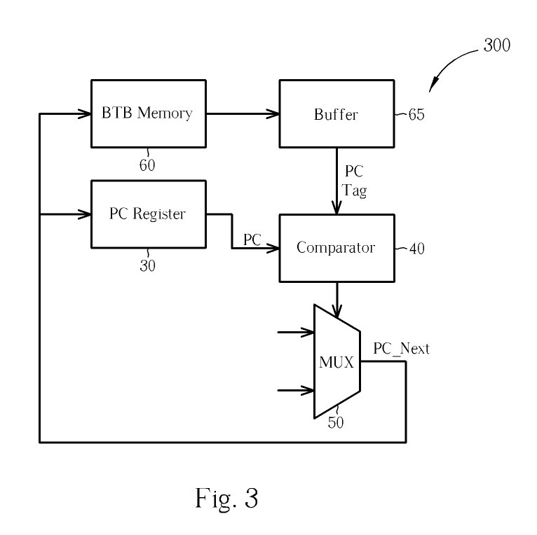

Please refer to FIG. 3. FIG. 3 is a diagram of a BTB system 300 according to an embodiment of the present invention. In this embodiment, the BTB system 300 comprises a BTB memory 60; a PC register 30; a comparator 40; a buffer 65; and a multiplexer 50. The BTB memory 60 contains a plurality of branch instructions.

Initially, the BTB memory 60 is empty. Every PC value that is input to the BTB memory 60 will return a BTB miss, as no data currently exists. When a branch instruction is determined by the system, however, that branch instruction will be stored in the BTB memory 60. In the prior art, the BTB memory 20 uses the PC value of the branch instruction as an index for storing the branch instruction. In this way, the next time the branch instruction is processed, the PC value of the branch instruction will be input to the BTB memory 20 and the related information can be output. In the present invention, however, the branch instructions are indexed according to a PC value of a previous sequential instruction. For example, suppose a series of instructions is represented by following program counter values (i.e. addresses):

n

n+4

n+8

n+12

t

wherein n+8 corresponds to the branch instruction, and the target address of the branch instruction is t. In the prior art, the branch instruction will be indexed utilizing the PC value of n+8. In the present invention, however, the branch instruction will be indexed utilizing the PC value of n+4.

The output of the BTB memory 60 is still pipelined into two stages in this embodiment. The output of the PC register 30, however, is only pipelined into one stage, that is, the output of the PC register 30 is directly input to the comparator 40. When the operation begins, the PC value of n will be input to the PC register 30 and the BTB memory 60. As n is not a branch instruction no value will be found in the BTB memory 60 and the BTB memory 60 will return a BTB miss response. This response is output to the buffer 65. As the output of the BTB memory 60 is pipelined into two stages, no value has been output to the comparator 40 at this first fetch stage. The comparator 40 therefore determines this as a BTB miss. The comparator 40 will input this result to the multiplexer 50, which utilizes the result to output a next PC value PC_Next that is a sequential PC value, i.e. n+4.

The PC value of n+4 will then be input to the PC register 30 and the BTB memory 60. The PC register 30 will output the PC value of n+4 to the comparator 40. As the branch instruction is indexed according to a prior PC value, when the PC value of n+4 is input to the BTB memory 60, the BTB memory 60 will output the PC tag of the branch instruction (n+8) to the buffer 65. At the same time, the buffer 65 outputs the result of instruction n to the comparator 40, where it is compared with the PC value of n+4. The comparator 40 will correctly determine that the current instruction is not a branch instruction, and the multiplexer 50 will determine to output a next sequential PC value, i.e. n+8, as the next PC value PC_Next.

When the PC value of n+8 is input to the BTB memory 60 no result will be found, as the branch instruction is indexed according to n+4. In this stage, a BTB miss will be output to the buffer 65. However, the PC value of the branch instruction is already stored in the buffer 65, and will be output to the comparator 40, where it is compared with the PC value of the current instruction. The BTB system 300 is therefore able to correctly determine that the current instruction is a branch instruction without needing to process a next sequential instruction.

It is an advantage of the present invention that no cycle penalty will exist when a branch instruction is processed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for predicting a target address of a branch instruction, the system comprising:
a branch target buffer (BTB), containing at least an entry storing the target address of the branch instruction, the entry being indexed according to a program counter (PC) value of an instruction prior to the branch instruction;
a PC register, containing a PC value of a current instruction; and
a comparator, coupled to the PC register and the BTB, for comparing the PC value of the current instruction with an output of the BTB corresponding to a previous instruction.

2. The system of claim 1, wherein the output of the BTB to the comparator is pipelined, and the output of the PC register is directly input to the comparator.

3. The system of claim 2, wherein the output of the BTB to the comparator is pipelined in two stages, and the system further comprises:
a buffer, coupled to the BTB, for buffering the output of the BTB in a first stage of a pipeline, and outputting the output of the BTB to the comparator in a second stage of the pipeline.

4. The system of claim 1, wherein each entry in the BTB contains a PC tag, and the output of the BTB is the PC tag.

5. The system of claim 1, further comprising:
a multiplexer, coupled to the comparing module, for utilizing a comparison result of the comparator to determine a next PC value to the BTB and PC register.

6. A method for predicting a target address of a branch instruction, the method comprising:
providing a branch target buffer (BTB), containing at least an entry storing the target address of the branch instruction, the entry being indexed according to a program counter (PC) value of an instruction prior to the branch instruction;
receiving a PC value of a current instruction;
utilizing the received PC value to output a BTB entry corresponding to a previous instruction and the PC value of the current instruction; and
comparing the PC value of the current instruction with the BTB entry corresponding to the previous instruction.

7. The method of claim 6, wherein the step of utilizing the received PC value to output the BTB entry corresponding to the previous instruction and the PC value of the current instruction comprises pipelining the BTB entry and directly outputting the PC value of the current instruction without being pipelined.

8. The method of claim 7, wherein the BTB entry is pipelined in two stages, and the step of utilizing the received PC value to output the BTB entry further comprises:
buffering the BTB entry in a first stage of a pipeline; and
outputting the buffered BTB entry as the BTB entry corresponding to the previous instruction in a second stage of the pipeline.

9. The method of claim 6, wherein the BTB entry is a PC tag.

10. The method of claim 6, wherein the step of comparing the PC value of the current instruction with the BTB entry corresponding to the previous instruction further comprises:
utilizing the comparison result to determine a next PC value.
